(19) United States
(12) Patent Application Publication
(10) Pub. No.: US 2026/0340088 A1
(43) Pub. Date: Oct. 29, 2026

(54) INFORMATION PROCESSING METHOD, INFORMATION PROCESSING DEVICE, AND RECORDING MEDIUM

(71) Applicant: Panasonic Intellectual Property Management Co., Ltd., Osaka (JP)

(72) Inventors: Kakuya YAMAMOTO, Hyogo (JP); Ayaka NAKASAKA, Osaka (JP); Junji MICHIYAMA, Fukuoka (JP)

(21) Appl. No.: 19/699,657

(22) Filed: Jun. 5, 2026

Related U.S. Application Data
(63) Continuation of application No. PCT/JP2024/044616, filed on Dec. 17, 2024.
(60) Provisional application No. 63/615,033, filed on Dec. 27, 2023.

(51) Int. Cl. G06F 21/10

(52) U.S. Cl. CPC G06F 21/108

(57) ABSTRACT

An information processing method includes: obtaining, in a case of a transfer of a non-fungible token (NFT) or a reference of the NFT, country information indicating a country or a country group of an execution source of the transfer or the reference of the NFT and a country or a country group of an execution destination of the transfer or the reference of the NFT, the NFT being associated one-to-one with a product or a service; and executing different processing relating to the transfer of the NFT between (i) a first case where the countries or the country groups of the execution source and the execution destination of the NFT are different from each other and (ii) a second case where the countries or the country groups of the execution source and the execution destination of the NFT are identical to each other.

### CROSS REFERENCE TO RELATED APPLICATIONS

This is a continuation application of PCT International Application No. PCT/JP2024/044616 filed on Dec. 17, 2024, designating the United States of America, which is based on and claims priority of U.S. Provisional Patent Application No. 63/615,033 filed on Dec. 27, 2023. The entire disclosures of the above-identified applications, including the specifications, drawings and claims are incorporated herein by reference in their entirety.

### FIELD

The present disclosure relates to an information processing method, a information processing device, and a recording medium.

### BACKGROUND

Various techniques relating to transfer of tokens are known (see Patent Literature (PTL) 1, for example).

### CITATION LIST

### Patent Literature

PTL 1: Japanese Patent No. 7490916

### SUMMARY

### Technical Problem

When a request to transfer a token or a request to refer to a token is obtained, it may be desirable that processing for the transfer or reference of the token not be uniformly executed.

In view of the above, the present disclosure provides an information processing method, an information processing device, and a recording medium capable of executing different processing for transfer or reference of a token.

### Solution to Problem

An information processing method according to an aspect of the present disclosure includes: obtaining, in a case of a transfer of a non-fungible token (NFT) or a reference of the NFT, country information indicating a country or a country group of an execution source of the transfer or the reference of the NFT and a country or a country group of an execution destination of the transfer or the reference of the NFT, the NFT being associated one-to-one with a product or a service; and executing different processing relating to the transfer of the NFT between (i) a first case where the country or the country group of the execution source of the NFT and the country or the country group of the execution destination of the NFT are different from each other and (ii) a second case where the country or the country group of the execution source of the NFT and the country or the country group of the execution destination of the NFT are identical to each other.

An information processing device according to an aspect of the present disclosure includes: an obtainer that obtains, in a case of a transfer of a non-fungible token (NFT) or a reference of the NFT, country information indicating a country or a country group of an execution source of the transfer or the reference of the NFT and a country or a country group of an execution destination of the transfer or the reference of the NFT, the NFT being associated one-to-one with a product or a service; and an executor that executes different processing relating to the transfer of the NFT between (i) a first case where the country or the country group of the execution source of the NFT and the country or the country group of the execution destination of the NFT are different from each other and (ii) a second case where the country or the country group of the execution source of the NFT and the country or the country group of the execution destination of the NFT are identical to each other.

A recording medium according to an aspect of the present disclosure is a non-transitory computer-readable recording medium having recorded thereon a program for causing a computer to execute the information processing method described above.

### Advantageous Effects

According to an aspect of the present disclosure, it is possible to implement an information processing method and the like capable of executing different processing for transfer or reference of a token.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating a configuration of an information processing system according to an embodiment.

FIG. 2 is a block diagram illustrating a functional configuration of a ledger server according to an embodiment.

FIG. 3 is a sequence diagram illustrating operations of an information processing system according to an embodiment.

FIG. 4 is a flowchart illustrating operations of a ledger server according to an embodiment.

FIG. 5 is an explanatory diagram illustrating a data structure of a blockchain.

FIG. 6 is an explanatory diagram illustrating a data structure of transaction data.

FIG. 7 is an explanatory diagram illustrating transaction data relating to execution of a smart contract.

FIG. 8 is a flowchart illustrating processing relating to execution of a smart contract.

FIG. 9 is an explanatory diagram illustrating structures of an NFT and metadata.

### DESCRIPTION OF EMBODIMENTS

### Circumstances Leading to the Present Disclosure

Recent years have seen the use of blockchain-based technologies for economic security purposes. For example, blockchain has been used to provide traceability proof as to whether a supply chain of a product or a service includes countries of a different bloc (i.e., a different country group). This makes it possible, for imports, to verify whether the risk of dependence on countries of a different bloc has been reduced, for example whether strategic autonomy or sovereignty is retained. For exports, it is possible to verify whether outflows of valuable resources etc. to foreign countries are being prevented, for example whether valuable resources etc. are flowing to countries of a different bloc.

Examples of the target (product or service) to be examined for outflow or dependence may include energy-related resources (for example, natural gas, crude oil, and electricity), rare-earth-related materials (for example, EV battery materials and permanent magnets for motors), active pharmaceutical ingredients, hydrogen, semiconductors, cloud services, or products (for example, manufacturing components and maintenance components) or services relating thereto.

When a token is transferred to or referenced in countries of such a different bloc or countries other than the domestic country, it may be desirable, from the viewpoint of economic security, to execute different processing for the transfer or reference of the token. PTL 1, however, does not disclose a technique for executing different processing for transfer or reference of the token.

In view of the above, the inventors of the present application have conducted extensive studies on an information processing method and the like capable of executing different processing for transfer or reference of a token, and have devised the information processing method and the like described below.

An information processing method according to a first aspect of the present disclosure includes: obtaining, in a case of a transfer of a non-fungible token (NFT) or a reference of the NFT, country information indicating a country or a country group of an execution source of the transfer or the reference of the NFT and a country or a country group of an execution destination of the transfer or the reference of the NFT, the NFT being associated one-to-one with a product or a service; and executing different processing relating to the transfer of the NFT between (i) a first case where the country or the country group of the execution source of the NFT and the country or the country group of the execution destination of the NFT are different from each other and (ii) a second case where the country or the country group of the execution source of the NFT and the country or the country group of the execution destination of the NFT are identical to each other.

Accordingly, different processing can be executed for the transfer or the reference of the NFT depending on whether the countries or the country groups of the source and the destination of the NFT are different.

Furthermore, for example, an information processing method according to a second aspect is the information processing method according to the first aspect, in which the different processing may include processing for hindering the transfer of the NFT in the first case compared to the second case.

Accordingly, processing for hindering the transfer of the NFT and processing for not hindering the transfer of the NFT can be executed as the different processing.

Furthermore, for example, an information processing method according to a third aspect is the information processing method according to the second aspect, in which the processing for hindering the transfer of the NFT may include at least one of prohibiting the transfer of the NFT or delaying the transfer of the NFT.

Accordingly, prohibiting the transfer of the NFT or delaying the transfer of the NFT can be executed as the processing for hindering the transfer of the NFT.

Furthermore, for example, an information processing method according to a fourth aspect is the information processing method according to the second aspect or the third aspect, in which the processing for hindering the transfer of the NFT may include permitting cancellation of the transfer of the NFT after the NFT is transferred.

Accordingly, the transfer of the NFT can be cancelled, which can serve as a countermeasure against erroneous transmission or money transfer fraud.

Furthermore, for example, an information processing method according to a fifth aspect is the information processing method according to any one of the second through fourth aspects, in which the processing for hindering the transfer of the NFT may include at least one of disabling a wallet that includes the NFT or decreasing a score indicating a reliability degree of the wallet.

Accordingly, at least one of disabling a wallet that includes the NFT or decreasing a score indicating the reliability degree of the wallet can be executed as the processing for hindering the transfer of the NFT.

Furthermore, for example, an information processing method according to a sixth aspect is the information processing method according to any one of the second through fifth aspects, in which the processing for hindering the transfer of the NFT may include changing a display mode of the NFT.

Accordingly, it is possible to present to the user that the country information are different from each other.

Furthermore, for example, an information processing method according to a seventh aspect is the information processing method according to any one of the first through sixth aspects, in which the different processing may include changing, in the first case, a degree relating to a supply chain of the product or the service, the degree being included in the NFT.

Accordingly, it is possible to, as the different processing, change the degree relating to the supply chain in the first case.

Furthermore, for example, an information processing method according to an eighth aspect is the information processing method according to the seventh aspect, in which the NFT may be associated with the product, and the different processing may include decreasing the degree when a country or a country group of a component or a material included in the product is different from a domestic country.

Accordingly, it is possible to decrease the degree as the different processing when a country or a country group of a component or a material included in the product is different from the domestic country.

Furthermore, for example, an information processing method according to a ninth aspect is the information processing method according to the seventh aspect or the eighth aspect, in which the NFT may be associated with the service, and the different processing may include decreasing the degree when a country or a country group of personnel, equipment, or energy used for maintaining the service is different from a domestic country.

Accordingly, it is possible to decrease the degree as the different processing.

Furthermore, for example, an information processing method according to a tenth aspect is the information processing method according to any one of the seventh through ninth aspects, in which the degree may include a self-sufficiency rate indicating a proportion of at least one of a component, a material, personnel, equipment, or energy used in the product or the service that is accounted for by at least one of a component, a material, personnel, equipment, or energy of a domestic country.

Accordingly, the self-sufficiency rate can be updated, thereby allowing the up-to-date self-sufficiency rate to be presented to the user.

An information processing device according to an eleventh aspect of the present disclosure includes: an obtainer that obtains, in a case of a transfer of a non-fungible token (NFT) or a reference of the NFT, country information indicating a country or a country group of an execution source of the transfer or the reference of the NFT and a country or a country group of an execution destination of the transfer or the reference of the NFT, the NFT being associated one-to-one with a product or a service; and an executor that executes different processing relating to the transfer of the NFT between (i) a first case where the country or the country group of the execution source of the NFT and the country or the country group of the execution destination of the NFT are different from each other and (ii) a second case where the country or the country group of the execution source of the NFT and the country or the country group of the execution destination of the NFT are identical to each other.

This provides advantageous effects similar to those of the above-described information processing method.

A recording medium according to a twelfth aspect of the present disclosure is a non-transitory computer-readable recording medium having recorded thereon a program for causing a computer to execute the information processing method.

This provides advantageous effects similar to those of the above-described information processing method.

Note that these general or specific aspects may be implemented using a system, a method, an integrated circuit, a computer program, or a non-transitory computer-readable recording medium such as a compact disc read-only memory (CD-ROM), or any combination of systems, methods, integrated circuits, computer programs, or recording media. The program may be recorded on a recording medium in advance, or may be supplied to a recording medium via a wide area communication network such as the Internet.

Hereinafter, exemplary embodiments will be specifically described with reference to the accompanying Drawings.

Note that each of the exemplary embodiments described below shows a general or specific example. The numerical values, constituent elements, the arrangement and connection of the constituent elements, steps, the processing order of the steps etc. shown in the following exemplary embodiments are mere examples, and are therefore not intended to limit the present disclosure. Further, among the constituent elements in the following exemplary embodiments, those not recited in any of the independent claims will be described as optional constituent elements.

Furthermore, the Drawings are represented schematically and are not necessarily precise illustrations. In addition, constituent elements that are substantially the same are given the same reference signs in the Drawings, and redundant descriptions thereof will be omitted or simplified.

In the present Specification, terms indicating relationships between elements, such as “same” and “identical”, as well as numerical values and numerical value ranges include, in addition to their exact meanings, substantially equivalent ranges including deviations of approximately a few percent (or approximately 10%), for example.

In the present Specification, ordinal numbers such as “first” and “second” are used not to imply a specific number or order of constituent elements unless specifically stated otherwise, but rather to avoid confusion among similar constituent elements and to distinguish them.

### Embodiment

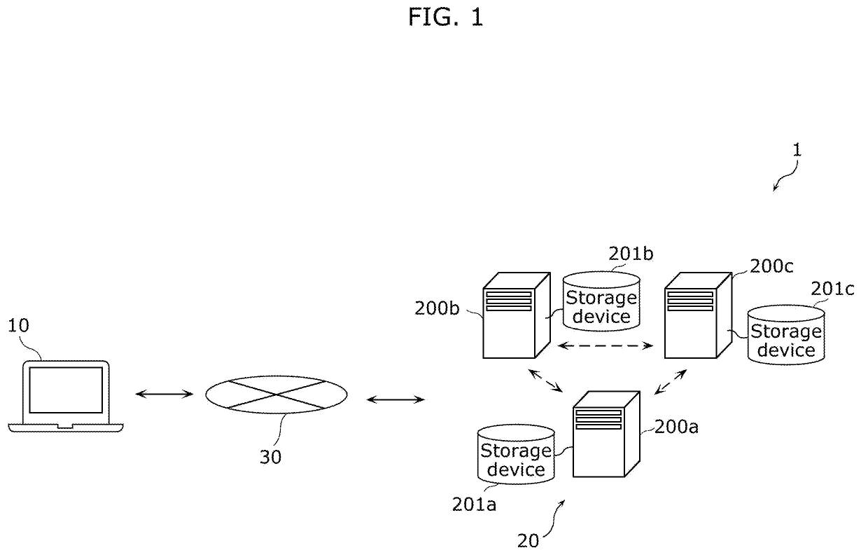

Hereinafter, an information processing system according to the present embodiment will be described with reference to FIG. 1 through FIG. 4.

### [1. Configuration of Information Processing System]

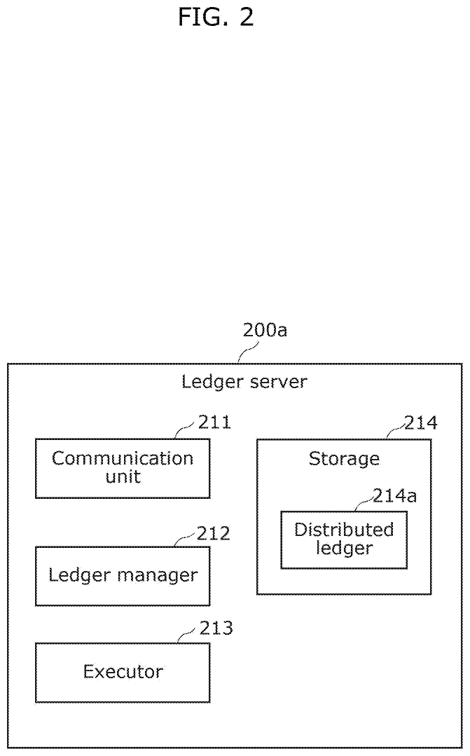

First, a configuration of the information processing system according to the present embodiment will be described with reference to FIG. 1 and FIG. 2. FIG. 1 is a diagram illustrating a configuration of information processing system 1 according to the present embodiment.

As illustrated in FIG. 1, information processing system 1 includes information terminal 10 and distributed ledger system 20. Information terminal 10 and distributed ledger system 20 are communicatively connected to each other via communication network 30.

Information terminal 10 executes processing relating to a non-fungible token (NFT) associated one-to-one with a product or a service. In the present embodiment, information terminal 10 generates transaction data for transferring an NFT or referring to an NFT (for example, a token of a different country), and transmits the transaction data to distributed ledger system 20. Information terminal 10 may be a portable device such as a smartphone or a tablet, a stationary device such as a personal computer (PC), or a server (for example, a cloud server).

Distributed ledger system 20 includes ledger servers 200a, 200b, 200c. They are communicatively connected to each other by communication network 30. Hereinafter, ledger servers 200a, 200b, 200c are also referred to as “ledger server 200a and the like”, and storage devices 201a, 201b, 201c are also referred to as “storage device 201a and the like”.

Ledger server 200a and the like are node terminals of distributed ledger system 20 and are connected to storage device 201a and the like. Ledger server 200a and the like may be connected to storage device 201a and the like via communication network 30, or may internally include storage device 201a and the like. Storage device 201a and the like each include distributed ledger 214a (see FIG. 2) on which transaction data and blocks of a blockchain are electrically recorded. For example, distributed ledger 214a stores information relating to an NFT (specifically, a generation history etc. of an NFT).

For example, distributed ledger system 20 stores information (for example, transaction data) relating to transfer of an NFT. The transaction data includes transaction data indicating delivery and receipt of a token (here, an NFT) between users (for example, between companies). The token includes at least an NFT. Further, the token may include value information in general (a monetary value or information equivalent to a monetary value). An “NFT” is a token having non-fungibility, and is typically a token compliant with ERC-721, which is an Ethereum blockchain standard; however, the NFT may be a token compliant with a different standard or a non-standard token, or may be a token on a blockchain other than the Ethereum blockchain. Although ERC-721 is a token standard for uniquely distinguishable tokens, the NFTs in the present Specification need not be uniquely distinguishable tokens. For example, a single NFT may correspond to ten products. Furthermore, a plurality of NFTs may be assigned to the same product. For example, different NFTs may be assigned to the same product depending on the day; that is, an NFT today and a different NFT tomorrow. Also, different NFTs may be assigned to the same product depending on the organization; that is, an NFT for organization A and a different NFT for organization B, for example.

Note that an NFT may include at least one of: information indicating a corresponding product or service; information indicating an owner of a product or a service; country information of the token or a wallet managing the token; in the case of a product, information relating to an NFT issued for each component of the product (for example, identification information or information indicating a storage location), or information relating to a manufacturing apparatus for manufacturing the product (for example, information indicating a country of manufacture of the manufacturing apparatus); or in the case of a service, information relating to maintenance of the service (for example, in the case of a cloud service, information relating to electric power consumed for the cloud service or information indicating the place of origin of a person involved in the cloud service). The NFT may also include a token ID for identifying the token.

Here, a configuration of ledger server 200a and the like will be described with reference to FIG. 2. FIG. 2 is a block diagram illustrating a functional configuration of ledger server 200a according to the present embodiment. Since the configurations of ledger servers 200b and 200c are similar to that of ledger server 200a, ledger server 200a will be described as an example. Note that FIG. 2 illustrates an exemplary functional configuration of ledger server 200a, and the functional configuration of ledger server 200a is not limited to that illustrated in FIG. 2.

As illustrated in FIG. 2, ledger server 200a includes communication unit 211, ledger manager 212, executor 213, and storage 214. At least one of the functional units included in ledger server 200a is implemented by a processor (for example, a central processing unit (CPU)) included in ledger server 200a executing a program using a memory.

Communication unit 211 is a communication interface communicatively connected to communication network 30. Communication unit 211 may be a communication interface conforming to a wired communication standard (for example, Ethernet (registered trademark), etc.) or may be a communication interface conforming to a wireless communication standard (for example, Wi-Fi (registered trademark) etc. or a mobile communications system (3G, 4G, or 5G, etc.)). Communication unit 211 is used when the functional units included in ledger server 200a communicate with other devices. For example, communication unit 211 is used when the functional units included in ledger server 200a communicate with information terminal 10, ledger servers 200b and 200c, other distributed ledger systems (not illustrated), other information processing devices, a server, or the like.

Ledger manager 212 performs processing relating to distributed ledger 214a and transaction data. Specifically, upon receiving transaction data from, for example, information terminal 10, ledger manager 212 performs control to verify a digital signature included in the received transaction data and store the successfully verified transaction data on distributed ledger 214a held in storage 214.

Executor 213 executes information processing. For example, executor 213 can execute information processing by executing a smart contract using distributed ledger 214a. Note that, in the case of not using a smart contract, executor 213 executes information processing according to a normal program code.

Storage 214 is a storage device that stores information. Storage 214 stores distributed ledger 214a. Storage 214 is implemented using a nonvolatile storage device (a solid-state drive (SSD) or a hard disk drive (HDD)), for example.

Distributed ledger 214a stores data structured as chained blocks, each including one or more transaction data items. The one or more transaction data items stored on distributed ledger 214a include transaction data including a contract code of a smart contract, transaction data including an instruction to execute a smart contract, or transaction data including other information.

In the present embodiment, distributed ledge 214a is a blockchain.

### [2. Operations of Information Processing System]

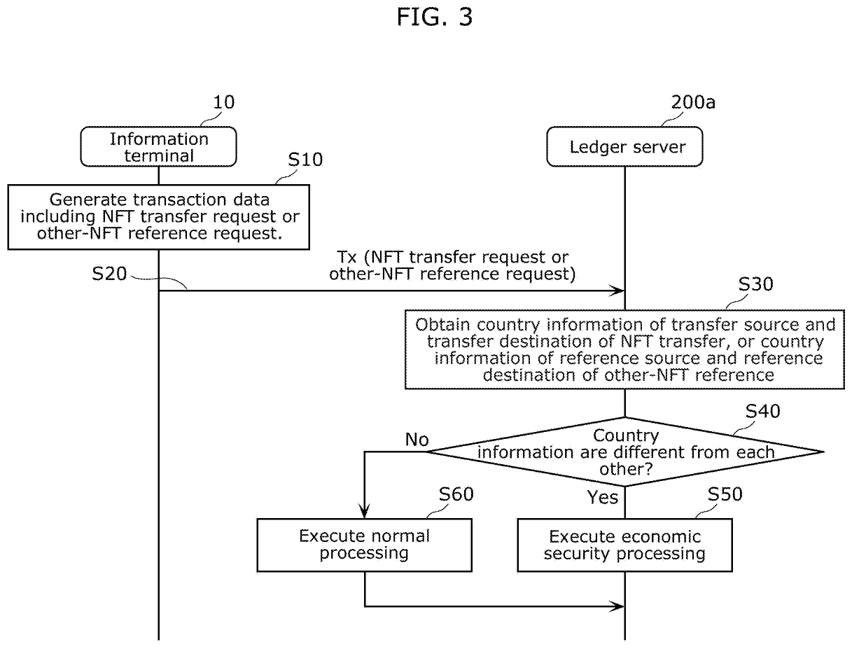

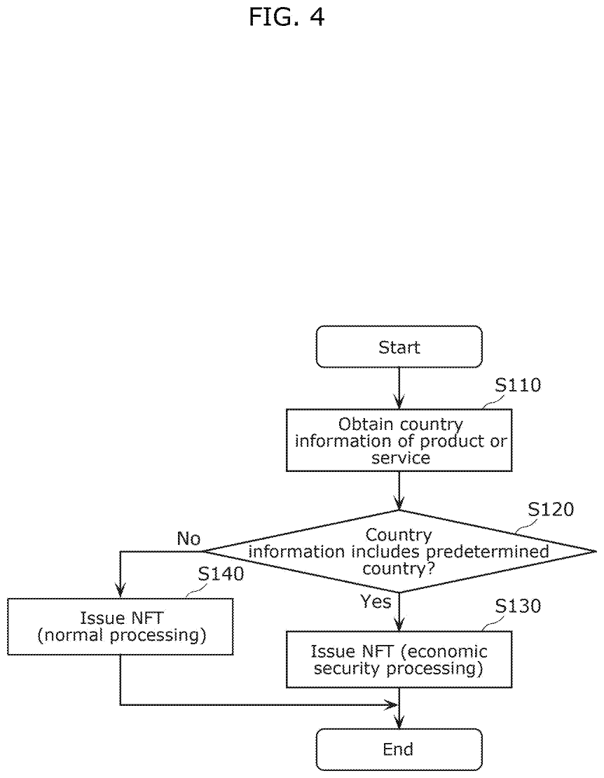

Now, operations of information processing system 1 configured as described above will be described with reference to FIG. 3 and FIG. 4. FIG. 3 is a sequence diagram illustrating operations (an information processing method) of information processing system 1 according to the present embodiment. FIG. 3 illustrates an example in which executor 213 executes the processing in steps S40 through S60. In this case, executor 213 may execute the processing in steps S40 through S60 in the case of receiving, in step S10, transaction data including an NFT transfer request or an other-NFT reference request that is a request to refer to an other NFT (for example, an NFT of a different country). Note that the processing in steps S40 through S60 are not limited to being executed by executor 213. Further, the processing in steps S30 through S60 may be executed, for example, before processing of ledger server 200a and the like is executed (for example, processing in which a consensus algorithm regarding the transaction data obtained in step S20 is executed among ledger server 200a and the like).

As illustrated in FIG. 3, information terminal 10 generates transaction data (Tx) including an NFT transfer request or an other-NFT reference request (S10), and transmits the generated Tx to ledger server 200a (S20). Information terminal 10 generates transaction data to be stored on the blockchain, based on, for example, information input from a user at the transfer source. For example, information terminal 10 generates transaction data including: a blockchain address held by the user; data to be managed on the blockchain (here, the NFT transfer request or the other-NFT reference request); and a signature. The transfer source is an example of the execution source.

An NFT transfer request is a request to transfer an NFT from the transfer source to a transfer destination. For example, the NFT transfer request may be a request to transfer an NFT from one wallet having an address to another wallet having a different address, or may be a request to alter, for instance, information on an NFT's user (for example, information about the NFT's owner) included in the NFT or information on a wallet that manages an NFT (for example, a request to overwrite information about the NFT's owner). The transfer destination is an example of the execution destination.

The other-token reference request is a request to refer to a different NFT linked to an NFT associated with a product or a service. For e xample, when the NFT is a token associated with a home appliance, examples of a different NFT include NFTs of components or materials of the home appliance, but are not limited thereto.

Next, when communication unit 211 of ledger server 200a obtains Tx from information terminal 10, communication unit 211 obtains country information of the transfer source and the transfer destination of the NFT transfer, or country information of the reference source and the reference destination of the other-NFT reference (S30). Communication unit 211 functions as the obtainer that obtains the country information. The reference source is an example of the execution source, and the reference destination is an example of the execution destination.

The country information includes a country, a country group, or the like. The country information may include the nationality of a user at the transfer source of an NFT and the nationality of a user at the transfer destination of the NFT, or may include country information of a wallet owned by a user at the transfer source of an NFT and country information of a wallet owned by a user at the transfer destination of the NFT. Further, the country information may include country information of a reference source NFT and country information of a reference destination NFT referred to by the reference source NFT, or may include country information of a wallet owned by a user of the reference source NFT and country information of a wallet owned by a user of the reference destination NFT referred to by the reference source NFT. Note that the country information may include unclear information such as “unknown” or “undetermined”. Further, the country group is a group including two or more countries that cooperate with each other by, for example, acceding to a treaty.

Communication unit 211 obtains the country information from, for example, information terminals such as smartphones used by the users at the transfer source and the transfer destination, or a dedicated device (for example, a dedicated device specialized according to a token type, such as a type of a token standard), but the present disclosure is not limited thereto. The dedicated device may be capable of determining the token type, for example. Note that the nationality of a user is not limited to a single nationality and may include plural (for example, two) nationalities.

Next, executor 213 determines whether the country information of the transfer source and the country information of the transfer destination are different from each other, or whether the country information of the reference source and the country information of the reference destination are different from each other (S40). When the transaction data includes a token transfer request, executor 213 determines whether the country information of the transfer source of the NFT and the country information of the transfer destination of the NFT are different from each other. The country information being different from each other may mean that the country or country group of the user at the transfer source is different from the country or country group of the user at the transfer destination.

Note that since national borders may change, countries may be subject to change. Further, since the members (for example, member states) of the country group may change, the country group may be subject to change. For example, the information on a country and a country group may be associated with the point in time to which the information pertains. If information indicating a certain point in time or later (for example, the most recent information) does not exist, the NFT transfer or the like may be rejected, or the information on the country and the country group may be updated.

Note that, for example, when the country information of the transfer source or the transfer destination is unknown, or when the country information of the reference source or the reference destination is unknown, it may be determined “Yes” in step S40, or processing other than steps S50 and S60 may be executed. The processing other than steps S50 and S60 may be processing that hinders the NFT transfer more than normal processing but less than economic security processing.

Note that executor 213 may determine “Yes” in step S40 when the country information of the wallet differs from the country information indicating the country where the wallet user is currently staying.

Next, executor 213 executes the economic security processing (S50) in a first case where the country information are determined to be different from each other (Yes in S40), and executes normal processing (S60) in a second case where the country information are determined to be identical to each other (No in S40). That is, executor 213 executes different processing relating to the transfer or reference of the NFT between (i) the first case where the country or country group of the transfer source of the NFT and the country or country group of the transfer destination of the NFT are different from each other, or the country or country group of the reference source of the NFT and the country or country group of the reference destination of the NFT are different from each other, and (ii) the second case where the country or country group of the transfer source of the NFT and the country or country group of the transfer destination of the NFT are identical to each other, or the country or country group of the reference source of the NFT and the country or country group of the reference destination of the NFT are identical to each other.

As the economic security processing in response to the token transfer request, executor 213 executes processing for hindering the transfer of the NFT in step S50 (the first case) compared to the second case. The processing for hindering the transfer of the NFT may include at least one of prohibiting the transfer of the NFT or executing processing for delaying the transfer of the NFT. Prohibiting the transfer of the NFT means preventing the NFT transfer from being carried out. Since an NFT is a token associated with a product or a service, prohibiting the transfer of the NFT means that the product or service associated with the NFT cannot be transferred either (for example, cannot be exported or imported). In this case, the transfer of the NFT is not executed even if transaction data including an NFT transfer request is obtained.

The processing for delaying the transfer of the NFT may include processing for postponing the timing at which the NFT transfer is executed; for example, executing the transfer after a lapse of a predetermined period or temporarily putting the transfer on hold. Because an NFT is a token associated with a product, delaying the transfer of the NFT means that the transfer of the product associated with the NFT will also be delayed (for example, export or import will be delayed). If a petition to execute the transfer is filed during the period in which the transfer is being delayed and the petition is granted, the delay may be canceled and the transfer of the NFT may be executed.

Furthermore, the processing for delaying the transfer of the NFT may include executing an additional request to the transfer source or the transfer destination for transfer; for example, additionally requesting information or performing additional confirmation for transfer. The additionally requested information includes information on at least one of the transfer source or the transfer destination, and examples thereof include an address, but are not limited thereto. The additional confirmation is, for example, to perform reconfirmation relating to the transfer of the NFT with at least one of the user at the transfer source or the user at the transfer destination, and examples thereof include reconfirming with at least one of the user at the transfer source or the user at the transfer destination whether to approve the transfer, but are not limited thereto.

Furthermore, the processing for delaying the transfer of the NFT may include permitting cancellation of the transfer of the NFT after the NFT is transferred. For example, the cancellation may be permitted only for a certain period of time after the NFT is transferred. Executor 213 executes cancellation of the transfer of the NFT, for example, when the user at the transfer source or the transfer destination requests, after the NFT is transferred, cancellation of the NFT transfer. That is, executor 213 executes processing to return the NFT from the transfer destination to the transfer source.

Furthermore, the processing for delaying the transfer of the NFT may include at least one of disabling a wallet that manages the NFT or decreasing a score indicating the reliability degree of the wallet. Disabling the wallet may be implemented by making it impossible to take out the NFT from the wallet. Furthermore, decreasing the score of the wallet may be implemented by decreasing the score of the wallet of the user at the transfer source or the transfer destination.

Note that the score may be increased or decreased based on a self-sufficiency rate that will be described later. For example, a lower self-sufficiency rate may lead to a greater decrease in the score. The self-sufficiency rate indicates a proportion of domestic components, materials, personnel, equipment, or energy used in the composition of a product or the maintenance of a service. Examples of the self-sufficiency rate include: a component self-sufficiency rate indicating a proportion of components, among a plurality of components used in a product or a service, that can be supplied domestically; a personnel self-sufficiency rate indicating a proportion of persons, among a plurality of persons who perform work for a product or a service, who are nationals of the domestic country (for example, persons having the nationality of the domestic country); an equipment self-sufficiency rate indicating a proportion of apparatuses, among a plurality of apparatuses used in manufacturing a product or maintaining a service, that can be supplied domestically; and an energy self-sufficiency rate indicating a proportion of energy (for example, electric power), out of energy supplied for manufacturing a product or maintaining a service, that can be supplied domestically. The self-sufficiency rate is an example of the degree relating to a supply chain. Note that the degree relating to a supply chain is not limited to a numerical value such as the self-sufficiency rate, and may be expressed as a rank such as high, medium, or low.

Furthermore, the processing for delaying the transfer of the NFT may include changing the display mode of the NFT when executing the transfer of the NFT. Examples of changing the display mode include changing the display color or changing the shape of a symbol mark included in the NFT, but are not limited thereto. The change in the display mode may be executed either irreversibly or reversibly. As a result, by displaying the NFT, it is possible to notify the user of the wallet managing the NFT that the NFT has been transferred to a different country. Note that a score may be assigned to the NFT itself, and the display color may be changed according to that score, for example. The score may be changed each time the NFT is transferred to a different country.

Note that executor 213 may execute processing according to a combination of nationalities if the user at the transfer source or the transfer destination has a plurality of nationalities. For example, when the user at the transfer source or the transfer destination has dual nationality, executor 213 may execute processing according to the combination of those countries. Even in the case of, for example, a dual-nationality wallet or a dual-nationality user, executor 213 may change the processing upon determining that a transfer of an NFT between different countries is requested (for example, step S50 may be executed). When a dual-nationality user has Japanese nationality and the nationality of a different country predetermined, executor 213 may, for example, determine “No” in step S40 when the dual-nationality user is currently in Japan, and determine “Yes” in step S40 when the dual-nationality user is currently in the different country predetermined.

Note that executor 213 may determine “Yes” in step S40 when the country of the transfer source or the transfer destination is using armed force or engaged in war, is experiencing ongoing natural disasters, or is subject to riots or similar conditions, in which cases there is a risk that products or services cannot be supplied stably, for example.

By hindering the transfer of the NFT as described above, it is possible to reduce the processing associated with the transfer of the NFT, thereby enabling reduction in the amount of processing performed by ledger server 200a and reduction in the electric power consumed by ledger server 200a. For example, since processing for executing a consensus algorithm for storing transaction data on ledger server 200a and the like may be omitted, it is possible to reduce processing associated with the transfer of the NFT. In addition, from a medium-to long-term perspective, unnecessary NFT transfers can be suppressed in advance; therefore, processing associated with the transfer of the NFT can be reduced.

In step S50, executor 213 may increase or decrease a predetermined numerical value included in the NFT, as the economic security processing in response to the other-token reference request. Increasing or decreasing the predetermined numerical value is an example of different processing relating to reference of an NFT. Note that the different processing relating to reference of an NFT is not limited to increasing or decreasing the predetermined numerical value, and may be other processing.

The predetermined numerical value may be, for example, a self-sufficiency rate relating to a product or a service. The self-sufficiency rate is an indicator inversely related to the degree of dependency, and may take a lower value as the degree of dependency increases. The predetermined numerical value varies according to, for example, the structure of the supply chain of a product or a service. When the product is a home appliance, the self-sufficiency rate is calculated as the proportion of components, among a plurality of components constituting the home appliance, that are domestically produced. If a large number of components are produced outside the domestic country (for example, in one or more predetermined foreign countries), the self-sufficiency rate of the home appliance is low. The transfer of the product or the service may be restricted according to the self-sufficiency rate.

Note that if the self-sufficiency rate is low, there is a risk that components may not be stably procured depending on the situations in the one or more predetermined foreign countries. In other words, when the self-sufficiency rate is low, the continued use of the home appliance may become difficult. If purchasers buy home appliances having high self-sufficiency rates, the risk of being unable to use the home appliances for a long period of time can be reduced. For example, for purchasers who prefer home appliances having high self-sufficiency rates, the self-sufficiency rate may serve as reference information when purchasing the home appliances.

Executor 213 may, as the different processing relating to reference of an NFT, decrease the self-sufficiency rate when a country or a country group of a component or a material included in a product is different from the domestic country. For example, executor 213 may trace information relating to a home appliance, such as components included in the home appliance, the suppliers of the components, and the suppliers of the materials used for manufacturing the components. If, for example, a country other than the domestic country (for example, a predetermined foreign country) is included, executor 213 may decrease the self-sufficiency rate of the home appliance. Furthermore, executor 213 may, as the different processing relating to reference of an NFT, decrease the self-sufficiency rate when a country or a country group of personnel, equipment, or energy used for maintaining the service is different from the domestic country.

Note that although the self-sufficiency rate is calculated at the start of sale of the home appliance, the self-sufficiency rate may change during the sales period due to changes in component suppliers, etc. Therefore, the self-sufficiency rate of the product or service is updated when it is determined “Yes” in step S40, so that the self-sufficiency rate is up to date.

As described above, when it is determined “Yes” in step S40, a predetermined numerical value included in the NFT, such as the self-sufficiency rate, may be updated. Note that if the self-sufficiency rate is updated due to a change in the component suppliers, the updated self-sufficiency rate is applied to the home appliance that includes the component supplied by the changed component supplier, whereas the previous self-sufficiency rate is applied to the home appliance produced before the self-sufficiency rate was changed. In other words, a plurality of self-sufficiency rates may exist for the same home appliance.

Note that the details of the economic security processing or the conditions for changes of the economic security processing may be changed depending on the NFT type or user information. For example, the method for calculating the self-sufficiency rate may be changed between refrigerators and washing machines, or between a first home appliance manufacturer and a second home appliance manufacturer.

Executor 213 executes normal processing (S60) in the second case where the country information are determined to match each other (No in S40). The normal processing refers to processing that does not include processing for hindering the transfer of the NFT, and an NFT transfer or an other-NFT reference is executed immediately according to the token transfer request or the other-token reference request.

Next, processing for issuing a token at the time of manufacturing a product will be described with reference to FIG. 4. FIG. 4 is a flowchart illustrating operations (an information processing method) of ledger server 200a according to the present embodiment. In FIG. 4, it is assumed that by the time when step S120 is executed, ledger server 200a has obtained transaction data that includes a request to issue an NFT.

As illustrated in FIG. 4, communication unit 211 obtains country information of a product or a service (S110). The country information of a product includes, for example, information indicating countries or country groups of components included in the product, the suppliers of the components, or the suppliers of the materials used for manufacturing the components. The country information of a service includes, for example, information indicating a country or a country group of personnel, equipment, or energy used for maintaining the service.

Next, executor 213 determines whether the country information includes a predetermined country (S120). For example, executor 213 determines whether the countries of the suppliers of the components and the countries of the suppliers of the materials used for manufacturing the components include the predetermined country.

If the country information includes the predetermined country (Yes in S120), the process proceeds to step S130, whereas if the country information does not include the predetermined country (No in S120), the process proceeds to step S140.

Note that the determination performed in step S120 may be replaced with determination as to whether the country information includes a foreign country. In this case, if the country information includes a foreign country, it is determined “Yes” in step S120 and the process proceeds to step S130, whereas if the country information does not include a foreign country, it is determined “No” in step S120 and the process proceeds to step S140.

Next, if the country information includes the predetermined country (Yes in S120), executor 213 executes economic security processing relating to issuance of an NFT (S130). The economic security processing here refers to processing for hindering the issuance of an NFT, and may include, for example, prohibiting or delaying the issuance of an NFT, or decreasing a predetermined numerical value included in an NFT (for example, decreasing the self-sufficiency rate).

If the country information does not include the predetermined country (No in S120), executor 213 executes normal processing relating to the issuance of an NFT (S140). The normal processing here refers to processing that does not include processing for hindering the issuance of an NFT, and the issuance of an NFT is executed immediately according to the token issuance request. (Various Data Structures and Execution of Smart Contract)

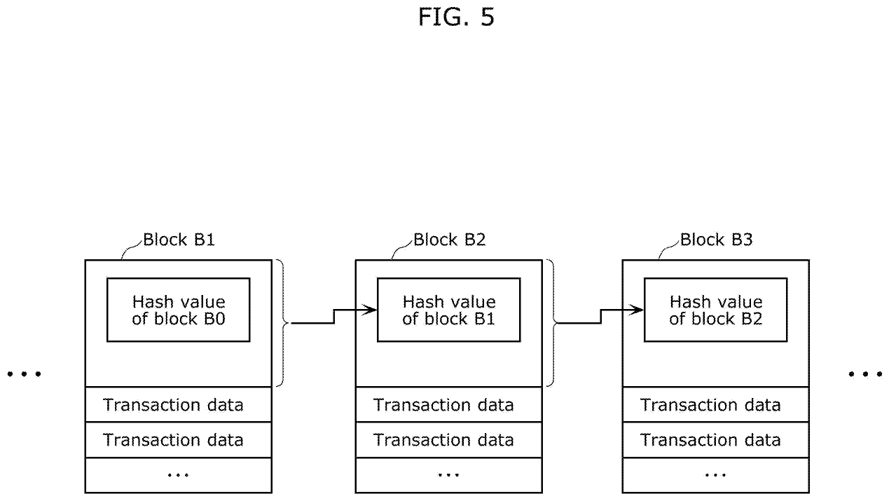

With reference to FIG. 5 through FIG. 9, the data structure of a distributed ledger, the execution of a smart contract, and the data structure of an NFT will be described.

FIG. 5 is an explanatory diagram illustrating the data structure of a blockchain, which is an example of the distributed ledger.

A blockchain is a structure in which blocks, each serving as a unit of record, are connected to form a chain. Each of the blocks includes a plurality of transaction data items and the hash value of the previous block.

FIG. 5 illustrates blocks B1, B2, and B3 included in the blockchain.

For example, block B2 includes the hash value of block B1, the previous block. The hash value of block B1 is a hash value calculated by computation performed on the content of block B1 according to a hash algorithm.

Block B3 includes, as the hash value of block B2, a hash value calculated from the plurality of transaction data items included in block B2 and the hash value of block B1.

Accordingly, the blockchain has the configuration in which the blocks each including the content of its previous block in the form of a hash value are connected to form a chain. Thus, the blockchain can effectively prevent tampering with the transaction data recorded.

If past transaction data is altered (in other words, tampered with), the hash value of the block including the transaction data differs from the value before the alteration. In this case, in order to make the block including the altered transaction data appear authentic, it is necessary to rebuild all the blocks following the block, which includes the altered transaction data, in the distributed ledger stored in each of a plurality of servers. This task is extremely difficult in reality. These characteristics can make it substantially impossible to tamper with the transaction data included in a blockchain.

Note that, to store transaction data on a blockchain, a node terminal (node) generates a block including the transaction data to be stored and executes processing based on a consensus algorithm for the generated block with the other nodes to reach a consensus with them. When the consensus is reached, the node performs control to store the block on the blockchain. Accordingly, a plurality of nodes operating in an autonomous and distributed manner can connect a valid block to the blockchain. As the consensus algorithm, practical byzantine fault tolerance (PBFT) may be used, or proof of work (PoW), proof of stake (PoS), or the like may be used. Note that, in the case where Hyperledger fabric is used as an example of a distributed ledger technology, the consensus algorithm need not be executed.

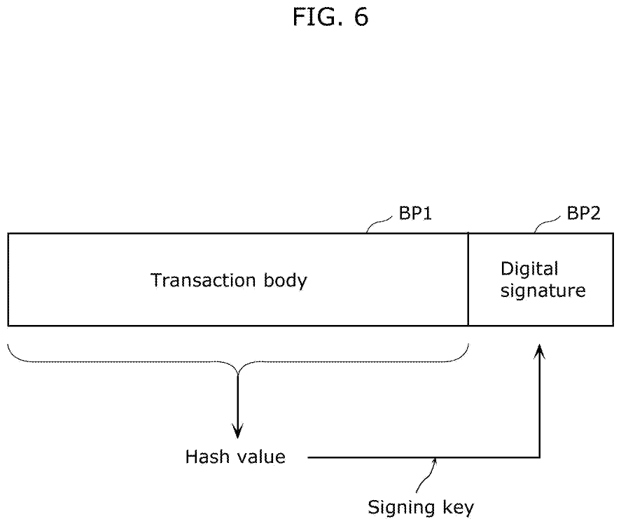

FIG. 6 is an explanatory diagram illustrating a data structure of transaction data.

Transaction data illustrated in FIG. 6 includes transaction body BP1 and digital signature BP2 (also simply referred to as a signature). Transaction body BP1 is the data body included in the transaction data. Digital signature BP2 is generated by encrypting the hash value of transaction body BP1 using a signing key of the creator of the transaction data (in other words, a private key).

Using digital signature BP2 included in the transaction data, a node that has received the transaction data can verify whether transaction body BP1 is valid (in other words, whether it is not tampered with). This may make it substantially impossible to tamper with the data included in transaction body BP1. In addition, by storing the successfully verified transaction data on a blockchain, it is possible to maintain the validity of the transaction data stored on the blockchain.

As described above, transaction data included in a blockchain are stored on the blockchain in a chain manner, using the hash values of the transaction data and the hash values of the blocks. Accordingly, the transaction data included in the blockchain are stored and maintained without being substantially tampering with. This is an advantage over a database or a distributed database in which a collection of data is simply stored.

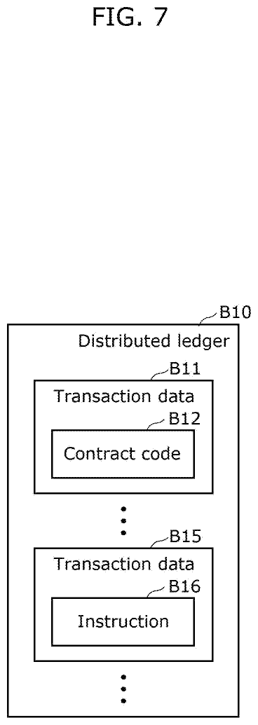

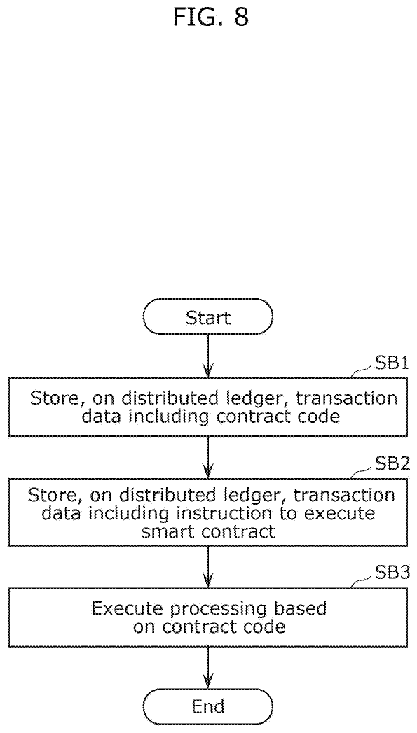

FIG. 7 is an explanatory diagram illustrating transaction data relating to execution of a smart contract. FIG. 8 is a flowchart illustrating processing (an information processing method) relating to execution of a smart contract.

With reference to FIG. 7 and FIG. 8, a series of steps relating to the execution of a smart contract using a distributed ledger will be described.

In step SB1, a node stores, on distributed ledger B10, transaction data B11 including contract code B12 in which processing of a smart contract is written. For example, the node obtains transaction data B11 by receiving transaction data B11 from a certain information processing device through communication or by generating transaction data B11 by itself, and stores obtained transaction data B11 on distributed ledger B10. Step SB1 is performed before the execution of the smart contract.

In step SB2, the node stores, on distributed ledger B10, transaction data B15 including instruction B16 to execute the smart contract. For example, the node receives transaction data B15 from a certain information processing device through communication and stores received transaction data B15 on distributed ledger B10.

In step SB3, in response to transaction data B15, which includes instruction B16, being stored on distributed ledger B10 in step SB2, the node reads contract code B12 from distributed ledger B10 and executes processing based on contract code B12. The result of the above processing may be included in transaction data and stored on distributed ledger B10.

By the above series of steps, upon receiving transaction data B15 including instruction B16 to execute the smart contract, the distributed ledger system executes the processing according to instruction B16 automatically (in other words, with no manual operations). Thus, it is possible to execute the processing with high efficiency (in other words, at high speed or in a short period of time). Achieving highly efficient processing brings about the advantageous effect of reduction in power consumption. In addition, dispensing with manual operations makes it possible to prevent tampering with information or misconduct by a person, or human errors beforehand. Furthermore, since the result of the processing executed in such a manner is stored on a blockchain, it is substantially impossible to tamper with the result of the processing.

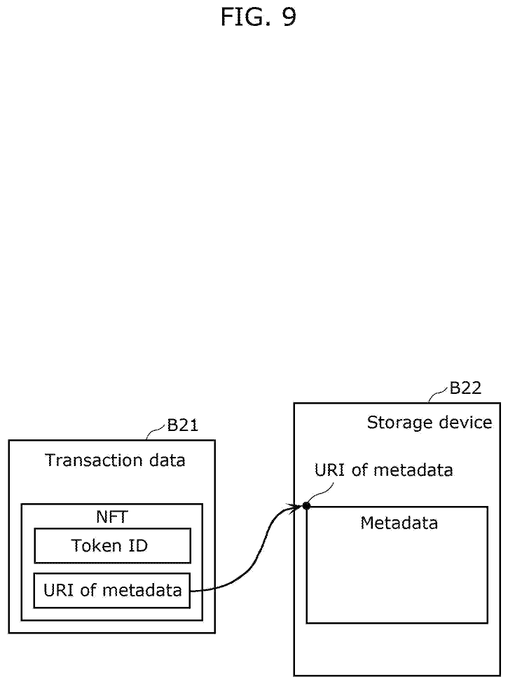

FIG. 9 is an explanatory diagram illustrating structures of an NFT and metadata. The NFT is a token stored on a distributed ledger. The NFT is a unique token (in other words, a non-fungible token). The NFT is standardized according to, but not limited to, for example, Ethereum Request for Comments (ERC) 721. The NFT may conform to a standard different from ERC-721, or may be non-standard (for example, specific to an organization). Note that although ERC-721 is a standard for unique tokens, the NFTs described in the present Specification need not necessarily be unique tokens.

FIG. 9 illustrates transaction data B21 stored on a distributed ledger. An NFT is stored in transaction data B21. The NFT includes a token ID (that is, identification information with which the NFT can be uniquely identified) and a uniform resource identifier (URI) of metadata.

The NFT includes metadata. The metadata may be placed at a location accessible via a network (for example, storage device B22). The URI of the metadata indicating the location of the metadata may be calculated using the token ID of the NFT and a predetermined base URI.

Information managed as the NFT may be included in transaction data B21, or may be included in the metadata. The inclusion of the information managed as the NFT in the metadata provides such an advantage that the amount of information included in transaction data B21 (in other words, information included in a blockchain) can be reduced. In this case, the metadata can be considered to include the actual content of the information managed as the NFT. In the case where an image is managed as an NFT, a uniform resource locator (URL) indicating image data of the image may be managed as the NFT.

Note that each of the constituent elements in the embodiment described above may be configured in the form of an exclusive hardware product, or may be implemented by executing a software program suitable for the constituent element. Each of the constituent elements may be implemented by means of a program executor, such as a CPU or a processor, reading and executing the software program recorded on a recording medium such as a hard disk or a semiconductor memory.

### Other Embodiments

Hereinbefore, an information processing method and the like according to one or more aspects have been described based on an exemplary embodiment, but the present disclosure is not limited to this embodiment. Various modifications of the present embodiment as well as forms resulting from combinations of constituent elements in different embodiments that may be conceived of by those skilled in the art may be included within the present disclosure so long as such modifications and forms do not depart from the essence of the present disclosure.

For example, although the blockchain is used in the above embodiment, the blockchain need not be used. For example, technologies are not limited to blockchain, and distributed ledger technologies such as Hashgraph may be used.

Further, for example, the processing in steps S40 through S60 described above are not limited to being executed by executor 213, and may be executed, for example, by a controller (which is not illustrated and is a processing unit that does not use a smart contract) included in ledger server 200a or by a device provided outside ledger server 200a.

Further, for example, although the above embodiment describes an example of imposing a restriction when transferring an NFT to a different country, the present disclosure is not limited thereto, and the transfer of an NFT may be restricted when transferring the NFT to a specific country or a specific country group. In other words, transfers of NFTs to a country or a country group other than the domestic country need not be restricted if it is not the specific country or specific country group.

In addition, for example, each device in the above embodiment is specifically a computer system including a microprocessor, a ROM, a random-access memory (RAM), a hard disk unit, a display unit, a keyboard, a mouse, and the like. A computer program is recorded in the RAM or on the hard disk unit. Each device achieves its function by the microprocessor operating in accordance with the computer program. Here, the computer program is constituted by a combination of a plurality of instruction codes that indicate instructions given to a computer to achieve a predetermined function.

In addition, for example, some or all of the constituent elements of the devices in the above embodiment may be implemented using a single large-scale integration (LSI) circuit. A system LSI circuit refers to a super multifunctional LSI circuit produced by integrating multiple constituent elements on a single chip, and specifically refers to a computer system including a microprocessor, a ROM, a RAM, and the like. A computer program is recorded in the RAM. The system LSI achieves its function by the microprocessor operating in accordance with the computer program. Further, system LSI circuits herein may also be referred to as integrated circuits (ICs), LSI circuits, super LSI circuits, or ultra LSI circuits depending on the degree of integration. Moreover, the manner in which the circuit integration is achieved is not limited to LSI, and it is also possible to use a dedicated circuit or a generic processor.

Further, the present disclosure may be, for example, the methods described above. Furthermore, the present disclosure may be a computer program for implementing these methods with a computer, or a digital signal of the computer program. For example, an aspect of the present disclosure may be a computer program that causes a computer to execute each characteristic step included in the information processing method illustrated in any of FIG. 3, FIG. 4, or FIG. 8.

In addition, the present disclosure may also be a computer program or a digital signal recorded on a computer-readable recording medium such as a flexible disk, a hard disk, a CD-ROM, a magneto-optical disk (MO), a digital versatile disc (DVD), a DVD-ROM, a DVD-RAM, a Blu-ray (registered trademark) Disc (BD), or semiconductor memory. The present disclosure may also be the digital signal recorded on these recording media.

In addition, the present disclosure may also be implemented by transmitting the computer program or the digital signal via, for example, a telecommunication line, a wireless or wired communication line, a network such as the Internet, or data broadcasting.

In addition, the order in which the steps in the flowchart and the sequence diagram are executed is a mere example given for specifically describing the present disclosure, and the order may be different from those described above. Furthermore, some of the steps described above may be executed simultaneously (in parallel) with other steps, and some of the steps described above may not be executed.

In addition, the divisions of the functional blocks in the block diagrams are mere examples, and a plurality of functional blocks may be implemented as a single functional block, a single functional block may be divided into a plurality of functional blocks, and some functions may be transferred to other functional blocks. Furthermore, the functions of a plurality of functional blocks having similar functions may be processed by a single hardware or software product in a parallelized or time-divided manner.

In addition, for example, ledger server 200a according to the above embodiment may be implemented as a single device, or may be implemented using a plurality of devices. In the case of implementing ledger server 200a using a plurality of devices, the constituent elements of ledger server 200a may be allocated to the plurality of devices in any manner. In the case of implementing ledger server 200a using a plurality of devices, the method of communication among the plurality of devices is not particularly limited; it may be wireless communication or may be wired communication. The devices may communicate with each other using a combination of wireless communication and wired communication.

### Industrial Applicability

The present disclosure is useful for information processing devices and the like that store transaction data on a distributed ledger.

1. An information processing method comprising:
obtaining, in a case of a transfer of a non-fungible token (NFT) or a reference of the NFT, country information indicating a country or a country group of an execution source of the transfer or the reference of the NFT and a country or a country group of an execution destination of the transfer or the reference of the NFT, the NFT being associated one-to-one with a product or a service; and
executing different processing relating to the transfer of the NFT between (i) a first case where the country or the country group of the execution source of the NFT and the country or the country group of the execution destination of the NFT are different from each other and (ii) a second case where the country or the country group of the execution source of the NFT and the country or the country group of the execution destination of the NFT are identical to each other.

2. The information processing method according to claim 1, wherein
the different processing includes processing for hindering the transfer of the NFT in the first case compared to the second case.

3. The information processing method according to claim 2, wherein
the processing for hindering the transfer of the NFT includes at least one of prohibiting the transfer of the NFT or delaying the transfer of the NFT.

4. The information processing method according to claim 2, wherein
the processing for hindering the transfer of the NFT includes permitting cancellation of the transfer of the NFT after the NFT is transferred.

5. The information processing method according to claim 2, wherein
the processing for hindering the transfer of the NFT includes at least one of disabling a wallet that includes the NFT or decreasing a score indicating a reliability degree of the wallet.

6. The information processing method according to claim 2, wherein
the processing for hindering the transfer of the NFT includes changing a display mode of the NFT.

7. The information processing method according to claim 1, wherein
the different processing includes changing, in the first case, a degree relating to a supply chain of the product or the service, the degree being included in the NFT.

8. The information processing method according to claim 7, wherein
the NFT is associated with the product, and
the different processing includes decreasing the degree when a country or a country group of a component or a material included in the product is different from a domestic country.

9. The information processing method according to claim 7, wherein
the NFT is associated with the service, and
the different processing includes decreasing the degree when a country or a country group of personnel, equipment, or energy used for maintaining the service is different from a domestic country.

10. The information processing method according to claim 7, wherein
the degree includes a self-sufficiency rate indicating a proportion of at least one of a component, a material, personnel, equipment, or energy used in the product or the service that is accounted for by at least one of a component, a material, personnel, equipment, or energy of a domestic country.

11. An information processing device comprising:
an obtainer that obtains, in a case of a transfer of a non-fungible token (NFT) or a reference of the NFT, country information indicating a country or a country group of an execution source of the transfer or the reference of the NFT and a country or a country group of an execution destination of the transfer or the reference of the NFT, the NFT being associated one-to-one with a product or a service; and
an executor that executes different processing relating to the transfer of the NFT between (i) a first case where the country or the country group of the execution source of the NFT and the country or the country group of the execution destination of the NFT are different from each other and (ii) a second case where the country or the country group of the execution source of the NFT and the country or the country group of the execution destination of the NFT are identical to each other.

12. A non-transitory computer-readable recording medium having recorded thereon a program for causing a computer to execute the information processing method according to claim 1.
